(19) United States
(12) Patent Application Publication
(10) Pub. No.: US 2025/0187140 A1
(43) Pub. Date: Jun. 12, 2025

(54) ULTRASONIC CONDITIONING DISK CLEANING MODULE

(71) Applicant: Applied Materials, Inc., Santa Clara, CA (US)

(72) Inventors: Ningzhuo CUI, Santa Clara, CA (US); Haosheng WU, Fremont, CA (US); Jianshe TANG, San Jose, CA (US); Shou-Sung CHANG, Mountain View, CA (US); Chad POLLARD, San Jose, CA (US)

(21) Appl. No.: 18/536,658

(22) Filed: Dec. 12, 2023

(51) Int. Cl. B24B 53/017; B08B 3/12

(52) U.S. Cl. CPC B24B 53/017; B08B 3/12; B08B 2203/007

(57) ABSTRACT

Embodiments of the disclosure include a conditioning disk cleaning assembly, including a cleaning tank, a cleaning fluid resource, and a pad conditioning assembly. The cleaning tank includes at least one tank wall, forming an interior volume configured to hold a cleaning fluid and at least one transducer disposed on the tank wall opposite of the interior volume and electrically coupled to a generator, wherein the transducer is configured to generate a series of pressure waves in the cleaning fluid. The cleaning fluid resource configured to supply the cleaning fluid to the interior volume. The pad conditioning assembly comprising a pad conditioner disk and one or more actuators, wherein the one or more actuators are configured to position the pad conditioner disk in a first position within the cleaning tank and a second position that is over a polishing surface of a polishing pad.

### BACKGROUND

### Field

Embodiments of the present disclosure generally relate to chemical mechanical polishing, and more specifically to an ultrasonic conditioning disk cleaning module and method for use in chemical mechanical polishing.

### Description of the Related Art

Integrated circuits are typically formed on substrates, particularly silicon wafers, by the sequential deposition of conductive, semi-conductive or insulative layers. After each layer is deposited, the layer is etched to create circuitry features. As a series of layers are sequentially deposited and etched, the outer or uppermost surface of the substrate, i.e., the exposed surface of the substrate, becomes successively less planar. This non-planar outer surface presents a problem for the integrated circuit manufacturer as a non-planar surface can prevent proper focusing of the photolithography apparatus. Therefore, there is a need to periodically planarize the substrate surface to provide a planar surface.

Chemical mechanical polishing is one accepted method of planarization. This planarization method typically requires that the substrate be mounted on a carrier or polishing head, with the surface of the substrate to be polished exposed. The substrate is then placed against a rotating polishing pad. The carrier head may also rotate and/or oscillate to provide additional motion between the substrate and polishing surface. Further, a polishing liquid, typically including an abrasive and at least one chemically reactive agent, may be spread on the polishing pad.

When the polisher is in operation, the pad is subject to compression, shear and friction producing heat and wear. Slurry and abraded material from the wafer and pad are pressed into the pores of the pad material and the material itself becomes embedded, matted, and even partially fused. These effects, sometimes referred to as “glazing,” reduce the pad's efficacy reducing the planarization quality. It is, therefore, desirable to condition the pad by removing trapped slurry, and unmatting, re-expanding or re-roughening the pad material using a conditioning disk mounted in a pad conditioner. The polishing pad can be conditioned after each substrate is polished, or after a number of substrates are polished. Over time, the conditioning disk in the pad conditioner becomes contaminated with slurry and abraded materials and must be cleaned. However, current systems and techniques, such as water spray systems, still leave behind excess contamination on, and embedded in, the conditioning disk. This left-over contamination is returned to the polishing pad and can lead to uneven wear of the polishing pad, increased maintenance downtime, and reduced yields.

Therefore, there is a need in the art for a method and device that can reliably and uniformly clean the conditioning disk.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

In one embodiment, a conditioning disk cleaning assembly is provided. The conditioning disk cleaning assembly includes a cleaning tank, the cleaning tank may include: at least one tank wall, forming an interior volume configured to hold a cleaning fluid; and at least one transducer disposed on the tank wall opposite of the interior volume and electrically coupled to a generator, where the transducer is configured to generate a series of pressure waves in the cleaning fluid. The assembly includes a cleaning fluid resource configured to supply the cleaning fluid to the interior volume. The assembly includes a pad conditioning assembly may include a pad conditioner disk and one or more actuators, where the one or more actuators are configured to position the pad conditioner disk in a first position within the cleaning tank and a second position that is over a polishing surface of a polishing pad.

In another embodiment, a chemical mechanical polishing station is provided. The chemical mechanical polishing station includes a rotatable platen. The station includes an conditioning disk cleaning assembly, may include: a cleaning tank, the cleaning tank may include: at least one tank wall, forming an interior volume configured to hold a cleaning fluid; at least one transducer disposed on the tank wall opposite of the interior volume and electrically coupled to a generator, where the transducer is configured to generate a series of pressure waves in the cleaning fluid. The station includes a cleaning fluid resource configured to supply the cleaning fluid to the interior volume. The station includes a controller may include a memory that includes computer-readable instructions stored therein, and the computer-readable instructions, when executed by a processor of the controller, cause: a first actuator to translate a pad conditioning disk from a position over the rotatable platen to a position over the interior volume of cleaning tank, a second actuator to position the pad conditioning disk in a cleaning fluid disposed within the cleaning tank, and the transducer to generate pressure waves in the cleaning fluid.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a pad conditioning assembly in accordance with embodiments described herein.

FIG. 2 illustrates a chemical mechanical polishing station that includes a pad conditioning assembly in accordance with embodiments described herein.

FIG. 3 illustrates a cross-sectional view of a portion of a conditioning disk assembly in accordance with embodiments described herein.

FIGS. 4A and 4B provide schematic top views of a chemical mechanical polishing station including an ultrasonic conditioning disk cleaning module in accordance with embodiments described herein.

FIG. 5 illustrates a schematic side cross-sectional view of an ultrasonic conditioning disk cleaning module in accordance with embodiments described herein.

FIGS. 6A-6B illustrate a portion of a conditioning disk assembly in accordance with embodiments described herein.

FIG. 7 is a process flow diagram of a method for cleaning a conditioning disk in accordance with embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

Chemical mechanical polishing (CMP) is one accepted technique for of semiconductor substrates planarization. This planarization method typically requires that the substrate be mounted on a carrier or polishing head, with the surface of the substrate to be polished exposed. The substrate is then placed against a rotating polishing pad. The carrier head may also rotate and/or oscillate to provide additional motion between the substrate and polishing surface. Further, a polishing liquid, typically including an abrasive and at least one chemically reactive agent, may be spread on the polishing pad.

When the polisher is in operation, the pad is subject to compression, shear and friction producing heat and wear. Slurry and abraded material from the wafer and pad are pressed into the pores of the pad material and the material itself becomes embedded, matted, and even partially fused. These effects, sometimes referred to as “glazing,” reduce the pad's efficacy reducing the planarization quality. It is, therefore, desirable to condition the pad by removing trapped slurry, and unmatting, reexpanding or reroughening the pad material using a pad conditioner. The pad can be conditioned after each substrate is polished, or after a number of substrates are polished.

After a number of pad conditioning cycles, the conditioning disk of the pad conditioner requires cleaning to remove slurry, and particulate contamination from the disk surface. Failure to clean the conditioning disk can cause uneven polishing pad wear, uneven substrate planarization results, and leave scratches in the surface of the substrate leading to a yield reduction. Current conditioning disk cleaning systems and techniques rely on water spray systems which leave behind excess particle contamination. This contamination can then become dislodged on the polishing head causing uneven polishing pad wear, uneven substrate planarization results, and leave scratches in the surface of the substrate a reduction in yield.

Therefore, there is a need for a method and device that can reliably and uniformly clean the conditioning disk to reduce the problems described above. Embodiments of the present disclosure generally relate to chemical mechanical polishing (CMP) of semiconductor substrates, and more specifically to an ultrasonic conditioning disk cleaning module and method for use in chemical mechanical polishing.

### Pad Conditioner

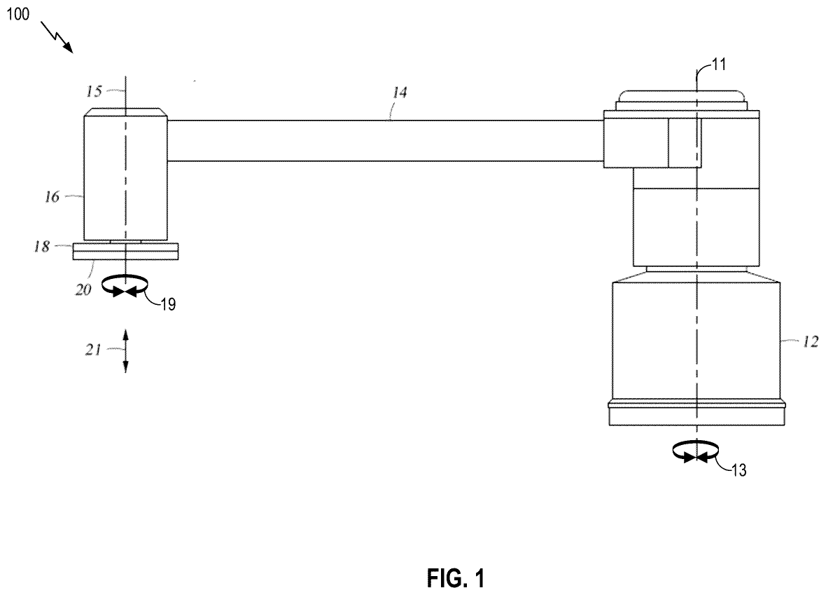

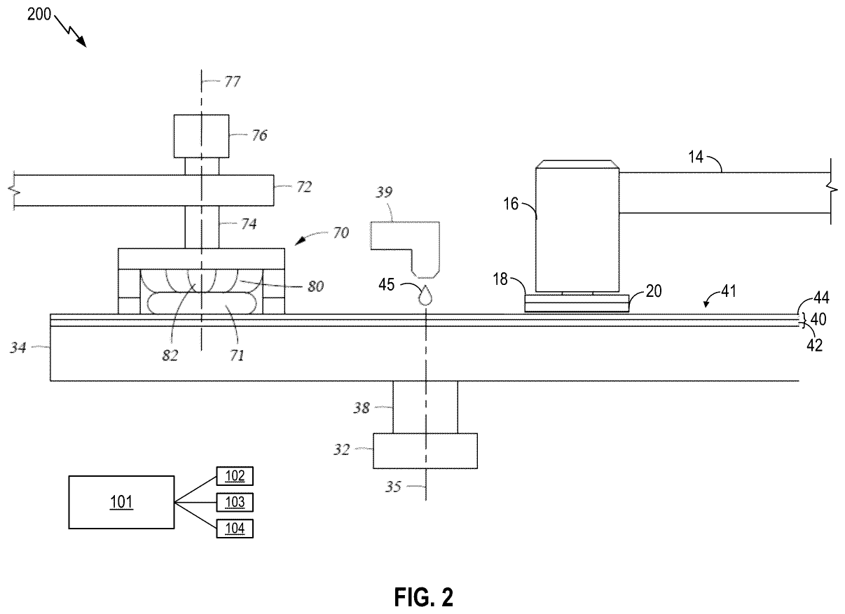

FIG. 1 illustrates a pad conditioner 100 that can be used in a chemical mechanical polishing (CMP) station 200 (FIG. 2). Pad conditioner 100 may include a conditioner base 12, a conditioner arm 14, a conditioner head 16, and a pad conditioner disk 18 mounted to conditioner head 16. Pad conditioner disk 18 may have a conditioning disk surface 23 of a pad conditioning element 20 that has abrasive particles disposed thereon. The pad conditioner disk 18 may be configured to rotate about a vertical axis 19. The conditioning disk surface 23 of the conditioning disk element 20 may be configured to rub against and abrade a surface of a polishing pad. Conditioner head 16 may include one or more components (e.g., inflatable bladder) that are configured to vertically move pad conditioner disk 18 (as indicated by arrow 21) from an elevated retracted position (as shown in FIG. 1) to a lowered extended position such that the conditioning disk surface 23 of the conditioning disk element 20 of the pad conditioner disk 18 may engage a polishing surface 41 (FIG. 2) of a polishing pad 40 (FIG. 2). Conditioner head 16 may further be configured to rotate pad conditioner disk 18 about vertical axis 15. In some embodiments, the conditioner head 16 includes a rotational actuator (e.g., air cylinder, electric motor, etc.) that is configured to rotate pad conditioner disk 18 about the vertical axis 15. Conditioner arm 14 may be configured to rotate about vertical axis 11 such that conditioner head 16 may sweep (as indicated by arrow 13) across a polishing surface 41 of the polishing pad 40 with a reciprocal motion. The rotating motion of pad conditioner disk 18 and the reciprocating motion of conditioner head 16 cause the conditioning disk surface 23 of pad conditioner disk 18 to condition the polishing surface of the polishing pad 40 by abrading the polishing surface 41 to remove contaminants and to retexture the surface.

### Chemical Mechanical Polishing Station

FIG. 2 is a side cross-sectional view of a portion of a chemical mechanical polishing (CMP) station 200. The CMP station includes a rotatable disk-shaped platen 34, which supports the polishing pad 40, and a carrier head 70 to hold a substrate 71 against the polishing pad 40. As discussed herein, the CMP apparatus can include multiple polishing stations. The polishing pad 40 can be a two-layer polishing pad with an outer layer 44 and a softer backing layer 42. In some cases, the polishing pad 40 can be a soft polishing pad, hard polishing pad, or a 3D printed polishing pad. That is, the construction materials of the polishing pad 40 can include soft materials, hard materials, or 3D printing materials, which can include polymeric materials. The polishing pad can have a hardness of 40 to 80 Shore D scale.

The disk-shaped platen 34 is operable to rotate about a central axis 35. For example, a motor 32 can turn a drive shaft 38 to rotate the disk-shaped platen 34 and polishing pad 40.

The carrier head 70 is suspended from a support structure 72, e.g., a carousel or a track, and is connected by a drive shaft 74 to a carrier head rotation motor 76 so that the carrier head can rotate about a central axis 77. Optionally, the carrier head 70 can oscillate laterally, e.g., on sliders on the carousel or support structure 72; or by rotational oscillation of the carousel itself. In operation, the platen is rotated about its central axis 35, and the carrier head is rotated about its central axis 77 and translated laterally across the top surface of the polishing pad 40.

The carrier head 70 can include a flexible membrane 80 having a substrate mounting surface to contact the back side of the substrate 71, and a plurality of chambers 82 to apply different pressures to different zones, e.g., different radial zones, on the substrate 71. The carrier head 70 can also include a retaining ring to hold the substrate.

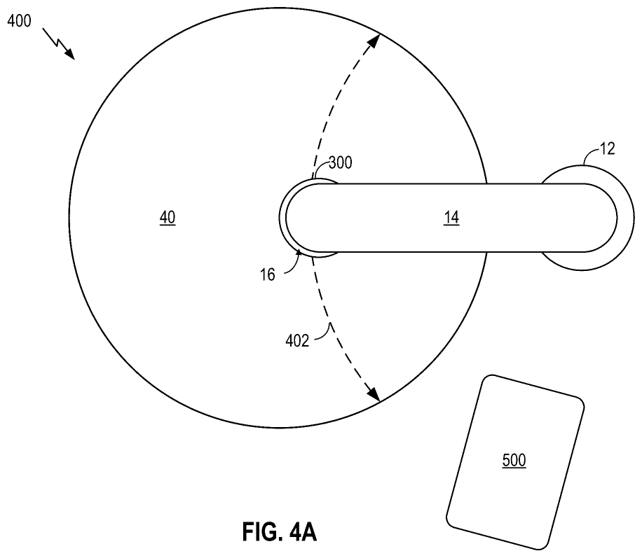

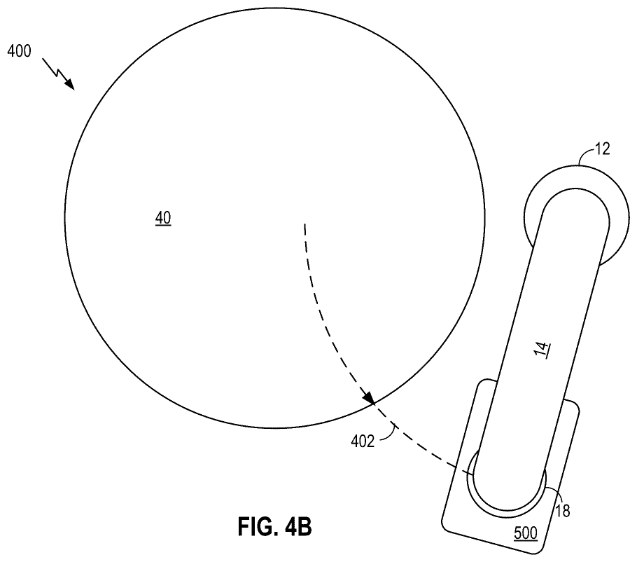

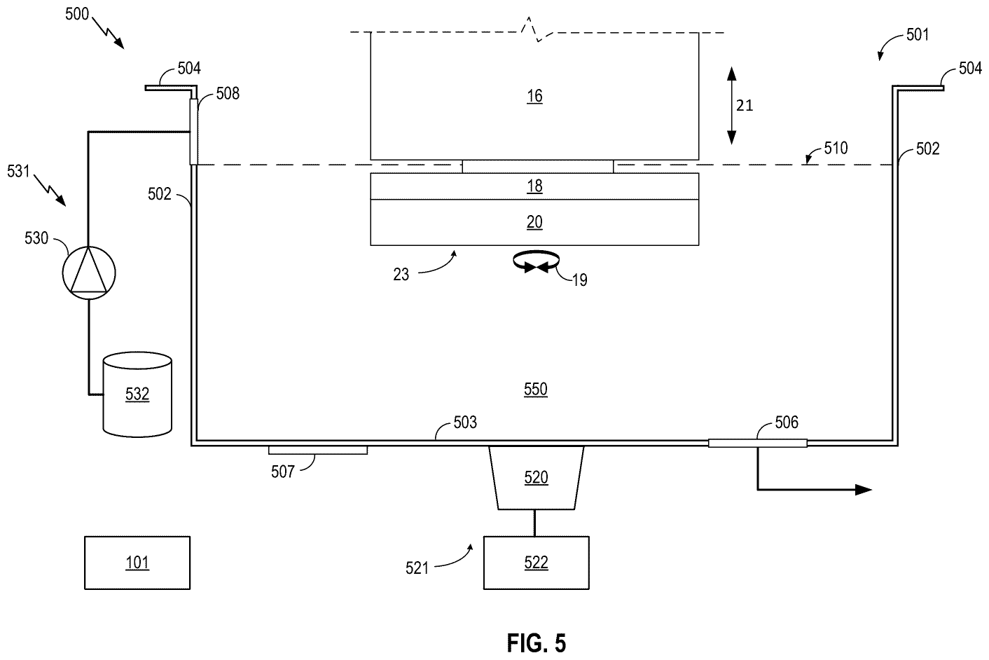

The CMP station 200 can include a supply port or a combined supply-rinse arm 39 to dispense a polishing liquid 45, such as slurry, onto the polishing pad 40. The CMP station 200 also includes pad conditioner 100. The CMP station 200 also includes an ultrasonic conditioning disk cleaning module 500 (Shown in FIGS. 4A, 4B, and 5).

The CMP station 200 may operate under the control of a controller 101. The controller 101 includes a programmable central processing unit (CPU) 102 which is operable with a memory 103 (e.g., non-volatile memory) and support circuits 104. The support circuits are conventionally coupled to the CPU and comprise cache, clock circuits, input/output subsystems, power supplies, and the like, and combinations thereof coupled to the various components of the CMP station 200, to facilitate control thereof. The CPU 102 is one of any form of general purpose computer processor used in an industrial setting, such as a programmable logic controller (PLC), for controlling various components and sub-processors of the processing system. The memory 103, coupled to the CPU 102, is non-transitory and is typically one or more of readily available memories such as random access memory (RAM), read only memory (ROM), floppy disk drive, hard disk, or any other form of digital storage, local or remote.

Typically, the memory 103 is in the form of a non-transitory computer-readable storage media containing instructions (e.g., non-volatile memory), which when executed by the CPU 102, facilitates the operation of CMP station 200. The instructions in the memory 103 are in the form of a program product such as a program that implements the methods of the present disclosure. The program code may conform to any one of a number of different programming languages. In one example, the disclosure may be implemented as a program product stored on computer-readable storage media for use with a computer system. The program(s) of the program product define functions of the embodiments (including the methods described herein).

Illustrative non-transitory computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory devices, e.g., solid state drives (SSD)) on which information may be permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the methods described herein, are embodiments of the present disclosure. In some embodiments, the methods set forth herein, or portions thereof, are performed by one or more application specific integrated circuits (ASICs), field-programmable gate arrays (FPGAs), or other types of hardware implementations. In some other embodiments, the substrate processing and/or handling methods set forth herein are performed by a combination of software routines, ASIC(s), FPGAs and, or, other types of hardware implementations. One or more controllers 101 may be used with one or any combination of the various systems described herein.

As used herein, ‘a CPU,” “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “memory,” “at least one memory,” or “or more memories” generally refers to a single memory configured to store data and/or instructions, multiple memories configured to collectively store data and/or instructions.

### Conditioning Disc Assembly

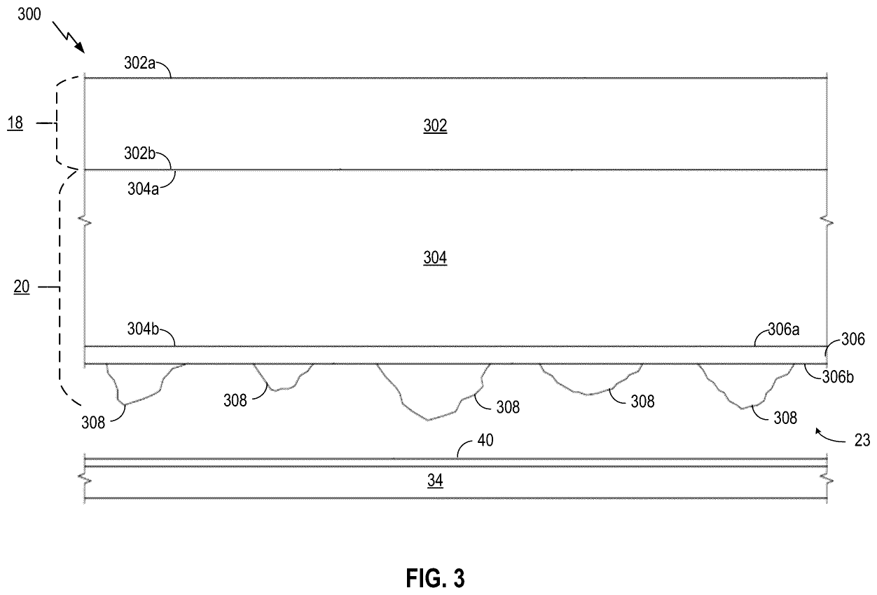

FIG. 3 illustrates a cross-sectional view of a portion of a conditioning disk assembly 300. As shown, the conditioning disk assembly 300 includes a pad conditioner disk 18 and conditioning disk element 20 disposed below the pad conditioner disk 18.

The pad conditioner disk 18 includes a support plate 302 having an upper support plate surface 302a and a lower support plate surface 302b. The conditioning disk element 20 includes, in some embodiments, a flexible member 304 having an upper flexible member surface 304a and a lower flexible member surface 304b, a disk element 306 having an upper disk element surface 306a and a lower disk element surface 306b, and abrasive media 308 that are coupled to the disk element 306.

The upper support plate surface 302a of support plate 302 is removably affixed to the conditioner head 16. The support plate 302 may be formed of any suitable rigid material or combination of materials. Example materials may include plastics, composites, metals, plastics, natural materials, resins, or ceramics. For example, the pad conditioner may be formed of stainless steel. In another example, the pad conditioner may be formed of epoxy-granite.

Affixed to the lower support plate surface 302b of the support plate 302 is a flexible member 304 comprised of a rubber, elastomer, silicone, or similar materials. In other embodiments, flexible member 304 may be made of a combination of rubber, elastomer, silicone, or similar materials.

The upper flexible member surface 304a of the flexible member 304 is affixed to the lower support plate surface 302b of the support plate 302. The lower flexible member surface 304b of the flexible member 304 is affixed to a disk element 306, comprising a material such as rubber, elastomer, silicone, thin metal plate (e.g., stainless steel, or aluminum (Al) foil or plate), a metal matrix, ceramic material, or a combination thereof. In some embodiments, the disk element 306 is configured to be flexible enough to distort under the load applied by an actuator in the conditioner base 12 during a conditioning process.

Abrasive media 308 is affixed to the lower disk element surface 306b of disk element 306. The abrasive media 308 may include any material of sufficient hardness. For example, silicon dioxide, aluminum oxide, cerium oxide, silicon carbide, diamond, metal oxides, nanoparticles, or a combination thereof.

In some embodiments, the abrasive media 308 is embedded into the lower disk element surface 306b of disk element 306. In some embodiments, the abrasive media 308 is embedded into the lower flexible member surface 304b of flexible member 304 and the disk element 306 is formed around the abrasive media 308 leaving at least a portion of the abrasive media 308 exposed below the lower disk element surface 306b of disk element 306. In this embodiment, the abrasive media 308 can be fixed to the disk element 306 by a variety of techniques. For example, the abrasive media 308 can be attached to the disk element 306 by way of known electroplating, chemical vapor deposition (CVD), and/or electrodeposition processes. As another example, the abrasive media 308 can be attached to the disk element 306 by way of organic binding, adhesives, brazing, or welding processes.

The disk element 306 is to deformable under the loads applied by an actuator in the conditioner base 12 configured to apply a downforce to the conditioning disk assembly 300 and pad 40 during a pad conditioning process. In some embodiments, the conditioner base 12 includes a first actuator (not shown), such as a linear actuator (e.g., air cylinder, linear motor, ball screw, etc.) that is configured to raise and lower the pad conditioner disk 18, the conditioner head 16 and conditioner arm 14, and a second actuator (not shown) that includes a rotational actuator (e.g., air cylinder, electric motor, etc.) that is configured to rotate the pad conditioner disk 18, the conditioner head 16 and conditioner arm 14 about the vertical axis 11. The flexible member 304 and disk element 306 flex to maintain constant contact between the individual abrasive media 308 as pressure is applied to the support plate 302 by use of the first actuator and/or components within the conditioner head 16.

FIGS. 4A and 4B provide schematic top views of a portion of a chemical mechanical polishing (CMP) station 400. To prepare for conditioning, and as shown in FIG. 4A, the conditioner arm 14 is rotated about the conditioner base 12 such that the conditioning disk assembly 300 are positioned over the polishing pad 40.

To perform conditioning, one or more actuators (not shown) inside the conditioner head 16, the conditioner base 12, or both, adjust the vertical position of the conditioning disk assembly 300 to engage the polishing pad 40. During conditioning, the conditioning disk assembly 300 is rotated in a predefined direction or path by one or more rotational actuators inside the conditioner head 16, the conditioner base 12, or both. The predefined direction or path may be counter-clockwise or clockwise as viewed from a top side of the polishing station. During conditioning, the conditioner arm 14 oscillates, about the conditioner base sweeping an arc path 402 across the polishing pad 40.

The CMP station 400 includes an ultrasonic conditioning disk cleaning module 500, described below. As shown in FIG. 4B, the conditioner arm 14 has moved the conditioning disk assembly 300 away from the polishing pad 40, along arc path 402, and into a position atop the ultrasonic conditioning disk cleaning module 500 that is positioned adjacent to the disk-shaped platen 34 within the CMP station 200.

### Ultrasonic Conditioning Disk Cleaning Module

FIG. 5 illustrates a cross-sectional view of an ultrasonic conditioning disk cleaning module 500. The ultrasonic conditioning disk cleaning module 500 includes a cleaning tank 501, a cleaning fluid assembly 531, and an ultrasonic cleaning assembly 521.

FIG. 5 also includes a partial view of conditioner head 16 including the pad conditioner disk 18 with conditioning disk element 20 mounted to conditioner head 16 that are inserted within a cleaning tank 501. FIG. 5 further shows the conditioner head 16 lowered to place the pad conditioner disk 18 with conditioning disk element 20 mounted at, or below, a configurable fill height 510 of the cleaning tank 501. In some embodiments, the pad conditioner disk 18 with conditioning disk element 20 may rotate about a vertical axis 19, the conditioner head 16 may move vertically, the conditioner arm 14 (not shown) may rotate about vertical axis, or any combination of movements, may occur while the ultrasonic conditioning disk cleaning module 500 performs the method described herein.

The cleaning tank 501 includes at least one tank side 502, a tank bottom 503, at least one mounting flange 504, at least one drain 506, at least one heater 507, and at least one fluid fill port 508.

The cleaning tank 501 includes the at least one tank side 502 and a tank bottom 503 form an interior volume to contain a cleaning fluid 550 within the cleaning tank 501. In some embodiments, the at least one tank side 502 and tank bottom 503 may form an interior volume that has a cuboid shape. In other embodiments, the at least one tank side 502 and tank bottom 503 may form an interior volume of a different geometric shape, for example, a cylindrical volume. The interior volume of the cleaning tank 501 is between about 0.1 liters to about 2 liters. For example, the interior volume of the cleaning tank 501 is between about 0.2 liters to about 1 liter. For example, the interior volume of the cleaning tank 501 is about 1 liter. The cleaning tank 501 may be formed from any suitable material, including metals, alloys, or polymers. For example, the cleaning tank 501 may be formed from stainless steel.

The cleaning tank 501 includes at least one mounting flange 504. Each of the at least one mounting flange 504 is disposed on an outside surface of the ultrasonic cleaning tank. The at least one mounting flange 504 is configurable to allow for under-mounting or over-mounting of the cleaning tank 501 to a CMP apparatus such as the CMP station 200.

The at least one tank side 502, tank bottom 503, and the at least one mounting flange 504 of the cleaning tank 501 are shown to meet at an angle, such as an orthogonal angle. In practice, the junction of the features may be orthogonal, angled, or meet in a rounded profile.

The cleaning tank 501 includes a fluid fill port 508 disposed on the tank side. In some embodiments, more than one fluid fill port 508 may be present. In other embodiments, the fluid fill port 508 may be disposed on the tank bottom 503. In other embodiments, the fluid fill port 508 may be disposed on the at least one mounting flange 504. In yet other embodiments, the fluid fill port 508 may be disposed over the cleaning tank 501.

The fluid fill port 508 is capable to discharge the cleaning fluid 550 into the cleaning tank 501. The fluid fill port 508 is further capable to discharge the cleaning fluid 550 into the cleaning tank 501 at a rate to maintain the cleaning fluid 550 within the cleaning tank 501 at a configurable fill height 510. In other embodiments, the fluid fill port 508 is further configured to discharge the cleaning fluid 550 into the cleaning tank 501 at a rate to maintain a configurable exchange rate for the cleaning fluid 550 to a drain 506. The configurable exchange rate may be set to replace the total volume of the cleaning fluid 550 within the cleaning tank 501 in a configurable time period. In other embodiments, the configurable exchange rate may be set to replace a configurable volume of the cleaning fluid 550 within cleaning tank 501 in the configurable time period.

The cleaning tank 501 includes at least one drain 506 for removing the cleaning fluid 550 disposed on the tank bottom 503. In other embodiments, the at least one drain 506 may be disposed on the at least one tank side 502 to act as a weir. In some embodiments, the at least one drain 506 is configured to send the removed cleaning fluid 550 for disposal, a “once-through” system. In other embodiments, the at least one drain 506 is configured to send the cleaning fluid 550 for treatment and reuse. In yet other embodiments, the at least one drain 506 is additionally configured to act as an overflow preventer.

The cleaning tank 501 includes at least one heater 507. In some embodiments, more than one heater may be present. The at least one heater 507 is capable to maintain the cleaning fluid 550 at a configurable cleaning fluid temperature. The configurable cleaning fluid temperature is between about 20° C. and about 90° C. For example, the configurable cleaning fluid temperature is about 70° C.

The at least one heater 507 is disposed on the tank bottom 503. In other embodiments, the heater may be disposed on the at least one tank side 502. In yet other embodiments, the at least one heater 507 may be disposed within the interior volume of the cleaning tank 501. The at least one heater 507 may be of any suitable type including, but not limited to, immersion heaters, heat exchangers, resistive heaters, inductive heaters, circulation heaters, radiant heaters, or any combination thereof.

The cleaning fluid 550 includes deionized water. In some embodiments, additives may be added including, but not limited to, chemicals, detergents, degreasers, acids, bases, or combination thereof. The cleaning fluid 550 can include DI water, one or more cleaning chemicals, or combinations thereof. In some embodiments, the one or more cleaning chemicals include an aqueous solution that includes a chemical that is an acid or a base. In some embodiments, the cleaning chemistries include a surfactant. In some embodiments, the cleaning chemistries includes at least one chemical selected from a group of sulfuric acid, hydrofluoric acid, phosphoric acid, hydrogen peroxide, ammonium hydroxide, tetramethylammonium hydroxide (TMAH), gallic acid, acetic acid, citric acid, monoethanolamine, hydroxylamine, and ammonium fluoride.

The cleaning fluid assembly includes at least one pump 530, and a cleaning fluid resource 532. The at least one pump 530 is coupled to the fluid fill port 508 and a cleaning fluid resource 532. The at least one pump 530 is configured to transport the cleaning fluid 550 from the cleaning fluid resource 532 to the fluid fill port 508. At least one pump 530 is configurable to deliver the transport the cleaning fluid 550 from the cleaning fluid resource 532 to the fluid fill port 508 at a configurable flow rate, and/or fluid pressure. The at least one pump 530 may be of any suitable type including, but not limited to centrifugal pumps, positive displacement pumps, diaphragm pumps, gear pumps, vane pumps, screw pumps, peristaltic pumps, jet pumps, electromagnetic pumps, pneumatic pumps, hydraulic pumps, syringe pumps, or any combination thereof. The cleaning fluid resource may include tanks, valves, accumulators, filters, sensors, or any combination thereof.

The ultrasonic cleaning assembly includes a transducer 520 and a generator 522. In some embodiments, more than one transducer 520 may be utilized. In other embodiments, more than one generator 522 may be utilized. In some embodiments, the transducer 520 includes a piezoelectric transducer (e.g. lead zirconate titanate (PZT), barium titanate, etc.) or a magnetostrictive type transducer.

The generator 522 is electrically coupled to the transducer 520. The generator 522 provides power and control over the generation of sonic energy waves by the transducer 520. The generator 522 is configured to deliver a series of electrical pulses to the transducer 520. The generator 522 is configured to deliver the series of electrical pulses to the transducer 520 for a configurable period of time. The configurable period of time is between about 1 second and 30 minutes, such as between 10 seconds and 2 minutes. For example, the configurable period of time is between about 30 seconds and about 90 seconds. For example, the configurable period of time is less than about 10 minutes.

The series of electrical pulses have a configurable electrical power and a configurable output frequency. The generator 522 is configured to supply electrical power to the transducer 520. The generator 522 is configured to supply between about 10 W and about 200 W of electrical power to the transducer 520. For example, the generator 522 is configured to supply between about 20 W and about 100 W of electrical power to the transducer 520. For example, the generator 522 is configured to supply 60 W of electrical power to the transducer 520.

The generator 522 is configured to control and output a frequency at which the transducer 520 operates to generate the sonic energy waves within the cleaning fluid 550. The output frequency of the generator 522 is between about 10 kilohertz (kHz) and about 300 KHz. For example, the output frequency of the generator 522 is between about 20 kilohertz (kHz) and about 200 kHz. For example, the output frequency of the generator 522 is about 40 KHz. For example, the output frequency of the generator 522 is about 60 kHz.

The generator 522 is configured to operate in a standalone fashion. In some embodiments, the generator 522 is configured to operate under the direction of an internal, or external, controller. For example, controller 101.

The transducer 520 is coupled to the tank bottom 503 and electrically coupled to the generator 522. In some embodiments the transducer 520 is coupled to the at least one tank side 502.

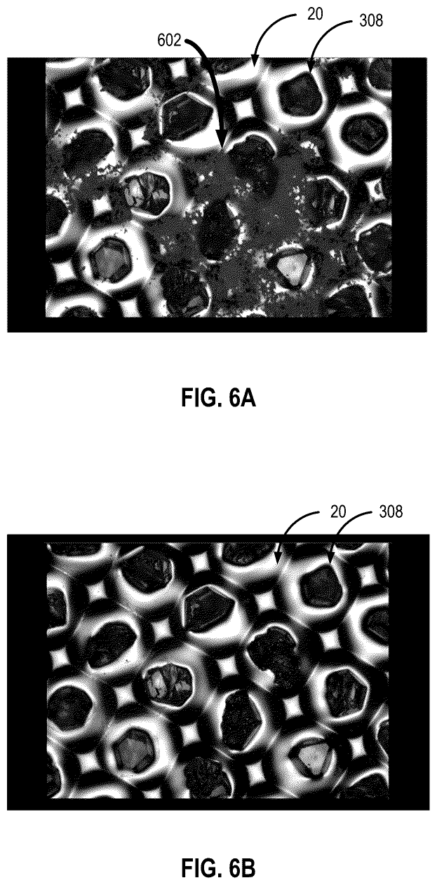

The transducer 520 is configured to receive the series of electrical pulses from generator 522. The transducer 520 is capable to transform the series of electrical pulses from generator 522 into a transmission of a series of mechanical waves to the interior volume of the cleaning tank 501. The series of mechanical waves transmit, as a series of pressure waves, via the cleaning fluid 550, through the interior volume of the cleaning tank 501 until the series of pressure waves impact the pad conditioner disk 18 with conditioning disk surface 23. Looking to FIG. 6A, which illustrates a portion of a conditioning disk assembly, the series of pressure waves will also impact any adhered contamination 602 present on the conditioning disk surface 23.

As the series of pressure waves travel through the cleaning fluid 550, the series of pressure waves create alternating high-pressure and low-pressure zones within the cleaning fluid 550. In the low-pressure zones, small bubbles or cavities form due to the reduced pressure. These bubbles continue to grow as the pressure decreases further. When the bubbles reach a critical size, the surrounding pressure increases, causing the bubbles to collapse or implode violently. This process is known as cavitation. The implosion of these bubbles generates intense shockwaves and microscopic jets of cleaning fluid 550. It is these shockwaves and cleaning fluid 550 jets that provide the cleaning action. The shockwaves and cleaning fluid 550 jets produced by cavitation create a cleaning action to dislodge and remove contaminants, such as portions of the polishing pad material (e.g., urethanes, acrylates, etc.), polishing slurry (e.g., Al₂O₃, CeOₓ, etc.), dielectric materials (e.g., SiOₓ, SiN, etc.), metals (e.g., Cu, W, Ta, Ti, Co, Al, etc.), grease, and other foreign particles from the surfaces of objects immersed in the cleaning fluid 550. The cleaning action is highly effective at reaching small crevices and intricate details that are difficult to clean by other methods, such as water spray cleanings.

By configuring the power and frequency of the series of electrical pulses delivered to the transducer 520 by the generator 522. The cleaning action of the cleaning fluid 550 can be tailored to have a greater effect on contaminants of a certain composition, or size range. For example, the power and frequency of the series of electrical pulses delivered to the transducer 520 by the generator 522 may be tailored to have an improved cleaning action on particle contaminants, such as polishing slurry or portions of the polishing pad surface, between about 0.1 micrometers (μm) and 500 μm. For example, looking to FIG. 6B, which illustrates a portion of a conditioning disk assembly, the cleaning action of the ultrasonic conditioning disk cleaning module 500 leaves the conditioning disk surface 23 with less contamination 602 as compared to the pre-cleaned state shown in FIG. 6A.

The cleaning action of the ultrasonic conditioning disk cleaning module 500 may allow for, among other things, a reduction in CMP downtime, an extended conditioning disk life lowering costs, improved pad conditioning efficiency, improved pad life, improved substrate output quality, and improved CMP throughput.

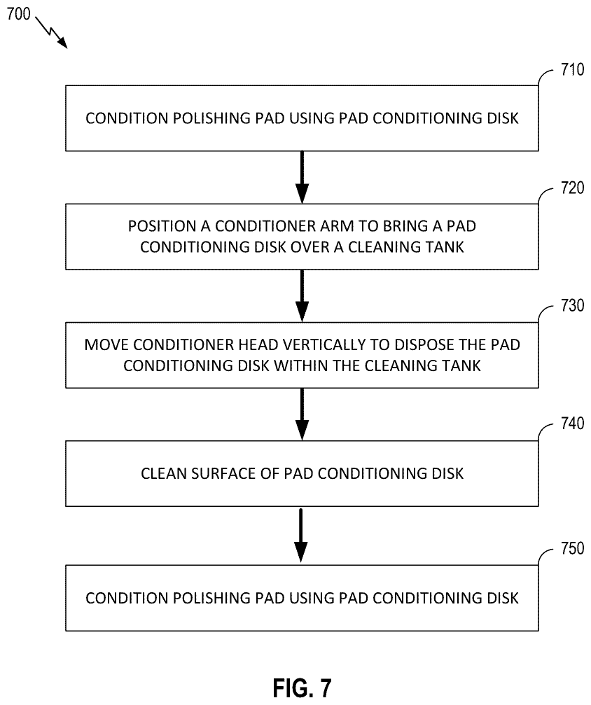

FIG. 7 is a process flow diagram of a method 700 for cleaning a conditioning disk assembly 300 using an ultrasonic conditioning disk cleaning module 500. Method 700 includes operations 710-750.

Operation 710 of method 700 includes conditioning the polishing pad 40 with the pad conditioning disk 18 described above until the pad conditioning disk 18 requires cleaning. The conditioning process will include causing the conditioning disk surface 23 of the pad conditioning disk 18 to abrade the surface of the polishing pad 40. The conditioning process can be performed before, during and/or after a polishing process is performed on a substrate. A polishing process will generally include the delivery of a slurry and one or more chemicals which are used to remove one or more materials from a surface of the substrate.

Operation 720 of method 700 includes translating a portion of the conditioner arm 14 and conditioner head 16 to position the pad conditioning disk 18 over the cleaning tank 501. Positioning the conditioner arm 14 to bring the conditioner head 16 over the cleaning tank 501 includes using one or more actuators inside the conditioner head 16, the conditioner base 12, or both, to adjust the vertical and horizontal position of the conditioning disk assembly 300 to transfer the pad conditioning disk 18 from a position over the polishing pad 40 to a position over the cleaning tank 501. In some embodiments, the conditioner head 16 of the conditioning disk assembly 300 is rotated in a predefined direction or path by one or more rotational actuators inside the conditioner base 12 to bring the conditioner head 16 over the cleaning tank 501.

Operation 730 of method 700 includes moving the conditioner head 16 vertically to dispose a pad conditioner disk 18 within the cleaning tank 501. Moving the pad conditioner disk 18 vertically to dispose a pad conditioner disk 18 within the cleaning tank 501 includes using one or more actuators inside the conditioner head 16, the conditioner base 12, or both, to adjust the vertical position of the pad conditioner disk 18 to bring the pad conditioner disk 18 below the configurable fill height 510 of the cleaning fluid 550 within the cleaning tank 501.

Operation 740 method 700 includes generating a cleaning action in the cleaning fluid 550. Generating a cleaning action in the cleaning fluid 550 includes delivering a series of electrical pulses to the transducer. The series of electrical pulses are delivered from a generator 522 to the at least one transducer 520. The transducer 520 is configured to receive the series of electrical pulses from generator 522. The transducer 520 is capable of transforming the series of electrical pulses into a generation and transmission of a series of mechanical waves into the interior volume of the cleaning tank 501. The series of mechanical waves transmit, as a series of pressure waves, via the cleaning fluid 550, through the interior volume of the cleaning tank 501 until the series of pressure waves impact the pad conditioner disk 18 and any contaminants present thereon.

As the series of pressure waves travel through the cleaning fluid 550, the series of pressure waves create alternating high-pressure and low-pressure zones within the cleaning fluid 550. In the low-pressure zones, small bubbles form due to the reduced pressure. These bubbles continue to grow as the pressure decreases further. When the bubbles reach a critical size, the surrounding pressure increases, causing the bubbles to collapse or implode violently. This process is known as cavitation. The implosion of these bubbles generates intense shockwaves and microscopic jets of cleaning fluid 550. It is these shockwaves and cleaning fluid 550 jets that provide the cleaning action. The shockwaves and cleaning fluid 550 jets produced by cavitation create a cleaning action to dislodge and remove contaminants.

In some embodiments, during the generation of the cleaning action in the cleaning fluid 550, the pad conditioner disk 18 may be rotated about a vertical axis, the condition head may be translated or oscillated in a horizontal direction within the cleaning fluid 550, the pad conditioner disk 18 may be translated or oscillated along the vertical axis, or any combination thereof of these various motions.

Operation 750 of method 700 includes removing the pad conditioning disk 18 from the cleaning tank and returning the pad conditioning disk 18 to a position over the polishing pad 40 to perform one or more pad conditioning processes until the next pad conditioning disk 18 cleaning process is required.

### ADDITIONAL CONSIDERATIONS

While this specification contains many specific implementation details, these should not be construed as limitations on the scope of what may be claimed, but rather as descriptions of features that may be specific to particular implementations. Certain features that are described in this specification in the context of separate implementations may also be implemented, in combination, in a single implementation. Conversely, various features that are described in the context of a single implementation may also be implemented in multiple implementations, separately, or in any suitable sub-combination. Moreover, although previously described features may be described as acting in certain combinations and even initially claimed as such, one or more features from a claimed combination may, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional) to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems may generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

While the various steps in an embodiment method or process are presented and described sequentially, one of ordinary skill in the art will appreciate that some or all of the steps may be executed in different order, may be combined or omitted, and some or all of the steps may be executed in parallel. The steps may be performed actively or passively. The method or process may be repeated or expanded to support multiple components or multiple users within a field environment. Accordingly, the scope should not be considered limited to the specific arrangement of steps shown in a flowchart or diagram.

Unless defined otherwise, all technical and scientific terms used have the same meaning as commonly understood by one of ordinary skill in the art to which these systems, apparatuses, methods, processes and compositions belong.

In this disclosure, the terms “top”, “bottom”, “side”, “above”, “below”, “up”, “down”, “upward”, “downward”, “horizontal”, “vertical”, and the like do not refer to absolute directions. Instead, these terms refer to directions relative to a nonspecific plane of reference. This non-specific plane of reference may be vertical, horizontal, or other angular orientation.

The singular forms “a,” “an,” and “the” include plural referents, unless the context clearly dictates otherwise. Within a claim, reference to an element in the singular is not intended to mean “one and only one” unless specifically so stated, but rather “one or more.” Unless specifically stated otherwise, the term “some” refers to one or more.

Embodiments of the present disclosure may suitably “comprise”, “consist” or “consist essentially of” the limiting features disclosed, and may be practiced in the absence of a limiting feature not disclosed. As used here and in the appended claims, the words “comprise,” “has,” and “include” and all grammatical variations thereof are each intended to have an open, non-limiting meaning that does not exclude additional elements or steps.

“Optional” and “optionally” means that the subsequently described material, event, or circumstance may or may not be present or occur. The description includes instances where the material, event, or circumstance occurs and instances where it does not occur.

As used, the term “determining” encompasses a wide variety of actions. For example, “determining” may include calculating, computing, processing, deriving, investigating, looking up, for example, looking up in a table, a database or another data structure, and ascertaining. Also, “determining” may include receiving, for example, receiving information, and accessing, for example, accessing data in a memory. Also, “determining” may include resolving, selecting, choosing, and establishing.

When the word “approximately” or “about” are used, this term may mean that there may be a variance in value of up to +10%, of up to 5%, of up to 2%, of up to 1%, of up to 0.5%, of up to 0.1%, or up to 0.1%.

Ranges may be expressed as from about one particular value to about another particular value, inclusive. When such a range is expressed, it is to be understood that another embodiment is from the one particular value to the other particular value, along with all particular values and combinations thereof within the range.

As used, terms such as “first” and “second” are arbitrarily assigned and are merely intended to differentiate between two or more components of a system, an apparatus, or a composition. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is envisioned under the scope of the various embodiments described.

As used, “a CPU,” “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

Although only a few example embodiments have been described in detail, those skilled in the art will readily appreciate that many modifications are possible in the example embodiments without materially departing from the disclosed scope as described. Accordingly, all such modifications are intended to be included within the scope of this disclosure as defined in the following claims.

What is claimed is:

1. A conditioning disk cleaning assembly, comprising:
a cleaning tank, the cleaning tank comprising:
at least one tank wall, forming an interior volume configured to hold a cleaning fluid; and
at least one transducer disposed on the tank wall opposite of the interior volume and electrically coupled to a generator, wherein the transducer is configured to generate a series of pressure waves in the cleaning fluid;
a cleaning fluid resource configured to supply the cleaning fluid to the interior volume; and
a pad conditioning assembly comprising a pad conditioner disk and one or more actuators, wherein the one or more actuators are configured to position the pad conditioner disk in a first position within the cleaning tank and a second position that is over a polishing surface of a polishing pad.

2. The conditioning disk cleaning assembly of claim 1, wherein the cleaning tank further comprises:
at least one fluid fill port disposed on the at least one tank wall, wherein the at least one fluid fill port extends through the at least one tank wall; and
at least one drain disposed on the tank wall, wherein the at least one the at least one drain extends through the tank wall.

3. The conditioning disk cleaning assembly of claim 1, wherein the interior volume is between about 0.2 liters and about 1 liter.

4. The conditioning disk cleaning assembly of claim 1, wherein the cleaning tank includes at least one heater disposed on an outside surface of the cleaning tank.

5. The conditioning disk cleaning assembly of claim 4, wherein the at least one heater is configured to maintain a cleaning fluid temperature between about 30° C. and about 80° C.

6. The conditioning disk cleaning assembly of claim 1, wherein the cleaning fluid comprises deionized water and at least one chemical selected from a group comprising an acid or a base.

7. The conditioning disk cleaning assembly of claim 1, wherein the cleaning fluid comprises deionized water and hydrogen peroxide.

8. The conditioning disk cleaning assembly of claim 1, wherein the series of pressure waves are generated at a frequency between about 20 kilohertz (kHz) and about 200 kHz by delivering a power between about 20 Watts (W) and 100 W to the transducer.

9. A chemical mechanical polishing station comprising:
a rotatable platen;
an conditioning disk cleaning assembly, comprising:
a cleaning tank, the cleaning tank comprising:
at least one tank wall, forming an interior volume configured to hold a cleaning fluid;
at least one transducer disposed on the tank wall opposite of the interior volume and electrically coupled to a generator, wherein the transducer is configured to generate a series of pressure waves in the cleaning fluid;
a cleaning fluid resource configured to supply the cleaning fluid to the interior volume; and
a controller comprising a memory that includes computer-readable instructions stored therein, and the computer-readable instructions, when executed by a processor of the controller, cause:
a first actuator to translate a pad conditioning disk from a position over the rotatable platen to a position over the interior volume of cleaning tank;
a second actuator to position the pad conditioning disk in a cleaning fluid disposed within the cleaning tank; and
the transducer to generate pressure waves in the cleaning fluid.

10. The conditioning disk cleaning assembly of claim 9, the cleaning tank further comprising:
at least one fluid fill port disposed on the at least one tank wall, wherein the at least one fluid fill port extends through the at least one tank wall; and
at least one drain disposed on the tank wall, wherein the at least one the at least one drain extends through the tank wall.

11. The conditioning disk cleaning assembly of claim 9, wherein
the translation of the pad conditioning disk from the position over the rotatable platen to the position over the interior volume of cleaning tank by the first actuator comprises pivoting the pad conditioning disk about a first axis by use of a rotational actuator; and
the positioning of the pad conditioning disk in the cleaning fluid disposed within the cleaning tank by use of the second actuator comprises translating the pad conditioning disk in a vertical direction by use of a vertical motion actuator.

12. The conditioning disk cleaning assembly of claim 9, further comprising:
a pump coupled to the cleaning fluid resource, and coupled to the cleaning tank, wherein the pump is configured to deliver the cleaning fluid from the cleaning fluid resource to the cleaning tank.

13. The conditioning disk cleaning assembly of claim 9, wherein the cleaning tank includes at least one heater disposed on an outside surface of the cleaning tank.

14. The conditioning disk cleaning assembly of claim 13, wherein the at least one heater is configured to maintain a cleaning fluid temperature between about 30° C. and about 80° C.

15. The conditioning disk cleaning assembly of claim 9, wherein the cleaning fluid comprises deionized water and at least one additive from a group comprising detergents, degreasers, acids, or bases.

16. The conditioning disk cleaning assembly of claim 9, wherein the cleaning fluid comprises deionized water and hydrogen peroxide.

17. The conditioning disk cleaning assembly of claim 9, wherein the series of electrical pulses occur at a frequency between about 20 kilohertz (kHz) and about 200 kHz at a power between about 20 Watts (W) and 100 W.

18. The conditioning disk cleaning assembly of claim 9, wherein the computer-readable instructions, when executed by a processor of the controller, further cause a cleaning action to be performed while the pad conditioning disk is disposed within the cleaning fluid, and the cleaning action continues from about 1 second to about 30 minutes.

19. The conditioning disk cleaning assembly of claim 9, wherein the generation of the series of pressure waves in the cleaning fluid comprises:
delivering the series of electrical pulses to the transducer; and
converting the series of electrical pulses into the series of pressure waves by the at least one transducer.

20. The conditioning disk cleaning assembly of claim 9, wherein the computer-readable instructions, when executed by a processor of the controller, further cause at least one of:
a third actuator to rotate the pad conditioning disk about a vertical axis while the pad conditioning disk is disposed in the cleaning fluid disposed within the cleaning tank; and
the first actuator to translate the pad conditioner disk within the cleaning fluid disposed within the cleaning tank.
